(19) United States
(12) Patent Application Publication
(10) Pub. No.: US 2005/0204893 A1
(43) Pub. Date: Sep. 22, 2005

(54) Plectrum

(76) Inventor: Ioan Luschniu, Nidda (DE)

Correspondence Address: LUSCHNIU IOAN, HOHENSTEINER STR. 13, NIDDA, D-63667, DE

(21) Appl. No.: 10/809,319

(22) Filed: Mar. 18, 2004

(51) Int. Cl. G10D 3/16

(52) U.S. Cl. 84/322

(57) ABSTRACT

A plectrum (1) is proposed vor striking strings whith at least two striking edges (11, 13) for striking several strings at the same time, and with at least two individual plectrums (3, 5) connected via a connection element (7, 7′, 7″). This is distinguished by the fact that the connection element (7, 7′, 7″), can be adapted to the index finger of the hand for holding the plectrum (1) with one hand.

The invention consists of a plectrum for striking strings.

Plectrums of the type addressed here are known. They can be out of striking rods or small flat pieces of material consisting of wood, ivory, plastic, metal or similar items and made with a pointed leaf-like shape. The plectrum can be held between two fingers and move over one or several strings, so that these are plucked or struck so that they sound. The production of a multiple sound when striking several strings is possible so that several notes can be sounded at the same time. The strings can also be struck with a faster rate of repetition, to produce a special sound, especially when playing guitars. It has been seen that the rate of repetition depends on the physiological limitations of the respective player, it cannot be increased again in other words. The striking of several strings exactly at the same time is also not possible. It is accordingly not possible to cause strings to sound simultaneously when they participate in a multiple sound.

The task of the invention is therefore to create a plectrum of the type stated at the beginning of this document that avoids this disadvantage. A plectrum is proposed as a solution for this task that has the features mentioned in claim 1. It is distinguished by the fact that is has at least two striking edges for striking several strings at the same time and/or striking one or several strings at the same time. This would accordingly make it possible to increase the rate of striking the strings, expressed as a factor of the manufactured striking edges that is normally limited by the player's agility. Striking several strings at the same time makes it possible to produce a synchronous multiple sound from the strings involved.

An example of the invention distinguished by the fact that the plectrum has at least two single plectrums joined by a connection element is preferred. This has the advantage of enabling the fingers to hold the single plectrums individually, so that they are relatively close to each other, at a distance where they are parallel to each other or where they can be positioned at an angle to each other. The connection element has a stabilising effect in this case and therefore supports the fastening of the single plectrums in the desired position.

An additional preferred example is distinguished by the fact that the connection element has flexible properties. This allows for several options for holding it with accordingly different relative lengths of the single plectrums in relation to each other. The flexible properties of the connection element can also be used so that there is a perceptible resistance when holding the single plectrums: this improves the accuracy of the position of the plectrum in the player's hand.

An additional preferred example is distinguished by the fact that the connection element has extremely floppy properties, a especially those of a foil, a string, cord, a tube, a textile tape, a wire and/or an elastic band. It will be possible by using these means for the connection element for mould into the anatomy of the players hand in a similarly way to that of an article of clothing so that is holding the plectrum becomes more comfortable.

An additional preferred example is distinguished by the fact that the connection element and the minimum of two single plectrums is constructed as one item. The plectrum is made out of one piece in other words so that manufacturing and assembly costs can be saved. This type of plectrum is also very stabile and long lasting.

An additional preferred example is distinguished by the fact that the minimum of two single plectrums are from a standard manufacturing series that is commercially available. The Plectrum can therefore be assembled from a standard manufacturing series that is commercially available with slight modifications, where necessary. There are no costs of development here.

There are further advantages to be found in the other sub-claims.

The invention will be described in more detail as follows by referring to drawings. These show:

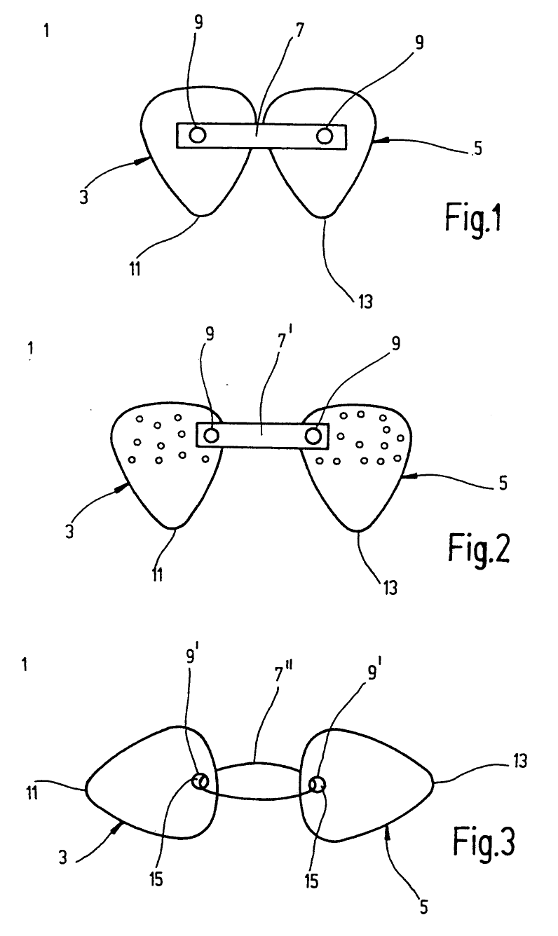

FIG. 1 a plectrum with two single plectrums and a connection element fitted in the middle,

FIG. 2 a plectrum with two single plectrums and a connection element fitted at the side and

FIG. 3 a plectrum with two single plectrums and a connection element.

FIG. 1 shows a plectrum 1 with a first single plectrum 3, a second single plectrum 5 and a lengthened, preferable strip-shaped connection element 7 has two connection elements 9, that are used to connect connection element 7 with the single plectrums 3, 5. The connection medium 9 is located here in the middle of the single plectrum 3, 5. The connection medium 9 is shown here in the example as a pliable adhesive compound in the drilled holes. Two drilled holes are located in the single plectrums 3, 5 for this purpose, which cannot be seen here and which are located behind connection method 9. The drilled ho-holes continue to connection element 7 and filled with the connection medium 9. Rivets, locking elements, screws or any other connection material is possible here. Instead of using connection material 9, that is to say, instead of using an adhesive compound.

Renunciation of the drilled holes and direct connection of connection element 7 with the single plectrums 3, 5 is also conceivable, possible by adhesion or welding.

Besides it is also possible to connect connection element 7 with the single plectrum 3, 5 as a single piece so as to dispense completely with connection material 9.

Connection material 9 can be produced is such a way that a twisting action can also take place along the drilled axis of the drilled holes 3, 5 in the plectrum relative to connection element 7: this increases flexibility in holding the plectrum 1.

Connection element 7 can have elastic properties at right angles to the length and can also be pliable. The use of a metal strip or a plastic foil is conceivable here This would enable plectrum 1 to be held in such a way that the single plectrum 5 can be lie between the thumb and the forefinger with plectrum 3 lying between the forefinger and the middle finger or the right hand so that the connection element passes over the upper edge or the lower edge of the forefinger to form a U shaped curve. The single plectrums have to be exchanged when holding with the left hand. The single plectrums 3, 5 are more or less parallel to each other. The pliable connection element 7 which can change shape can also lie around the fingertip of the forefinger to help in positioning the single plectrum 3, 5 between the thumb forefinger and mid-finger. A first striking edge 11 and a second striking edge 13 have to be positioned at the same time that they point outwards when viewed from the curved hand. The striking edges 11, 13 can therefore be deliveratelly moved over the striking of the instrument so that these are brought into motion.

The fact that a movement of the thumb causes the single plectrum 5 to change its relative position when held between the forefinger and the thumb is also an advantage. This means that the relative position single plectrums 3, 5 can be changed in relation to each other so that these are no longer parallel to each other. This therefore results in the distance of the striking edges 11, 13 changing: they are varied by a movement of the thumb in other words. This is especially of advantage it two strings are caused to sound at the same time to produce a multiple sound. The distance of the striking edges 11, 13 can therefore be precisely adapted to the string height of the respective instrument to enable simultaneous striking of adjacent strings or lose located further apart from each other.

The single plectrums 3, 5 can be at different angles to each other and to the playing direction, because of the alterable position. Differing sounds results accordingly: this has the effect of producing certain rhythmical patterns such as an emphasis on the first beat or facilitates the playing of fugues and the creation of tension for the listener. A softer sound can be produced by one of the single plectrums 3, 5 for example and a harder sound with the other. It also possible to use the single plectrums 3, 5 to strike the strings respectively from the other side which then provides precise 4/4 time on two strings. The strings can therefore be plucked from below with one of the single plectrums 3, 5 and from the top with the other one when playing the guitar. Finally one of the single plectrums 3, 5 can also be used for creating a precise beat and the other can be used for producing a cluster of sound.

It must also be recognized that the example described here is essentially moved parallel to the playing direction relative to the longitudinal axis when plectrum 1 is used to play with a curved connection element 7. Playing direction is understood to be a plane that is mainly parallel to the strings of a musical instrument. Connection element 7 can be have a pliable structure in the longitudinal direction.

FIG. 2 shows a plectrum 1 with single plectrums 3, 5 and a connection element 7′ fitted at the side, so that reference is made to the previous figure as far as this is concerned.

Compared to the previous example, the connection material 9 of a connection element 7′ is fitted to the side of a single plectrum 3, 5. Connection element 7, is also pliable so that plectrum 1 can be held in a similar way to the previously described example. However, the fact that the connection material 9 is located on the side leads to a changed holding position of the single plectrums of plectrum 1 so this can be positioned in the fingers closer to the wrist. Plectrum 1 can accordingly be posiioned differently in the hand according to the respective habits of the person playing plectrum 1 because of the differing positioning of connection material 9 and because of the length of connection element 7′. Connection element 7′ in this example is also has a pliable construction when viewed longitudinally and has extremely floppy properties. Plectrum 1 and therefore the single plectrum 3, 5 can be positioned more towards the wrist by slightly stretching the connection element 7′. This allows for even more variability and adaptation when holding plectrum 1. The extremely floppy properties of connection element 7′ enable it to be adapted to the shape of the tip of the forefinger which increases comfort in holding plectrum 1. Various options are shown in a dotted form for positioning connection material 9 of connection element 7′ on plectrum 1, which allow for even more advantageous adaptation of the form of plectrum 1 to the respective player and/or the playing style.

Connection element 7′ can be shaped in various ways, it can have a non-skid surface, be provided with notches and/or have captive perceptible elements. Plectrum 1 lies more securely in the hand when playing because of a non-skid surface and can be better moved for this reason. Various types of notches (rounded or saw tooth shaped) which can be located symmetrically or asymmetrically on the long edge or on both log edges of connection element 7′ can fabuality influence the elasticity and the ability to change shape so that it adapts better to the contours of the fingers when plectrum 1 is being held. The notches can be felt when holding and playing the plectrum, this acts as a positive support port when striking the strings in a controlled manner. It is also conceivable that connection element 7′ can be produced in a curved, convex or concave manner so that that it is different from a rectangular shape in the are of one or both long edges this would also add to better ergonomics plectrum 1.

FIG. 3 shows plectrum 1 with two single plectrums 3, 5 and a connection element 7″. The same parts are provided with the same reference lettering so that attention is drawn to the previous figures as far as this is concerned.

The connection materials 9′ of plectrum 1 in this example are fitted to striking edges 11, 13 on the opposite side of individual plectrum 3, 5 . Connection material 9′ of the single plectrums 3, 5 has drilled holes 15, through which connection element 7′, is fitted. Connection element 7′, is ring shaped and can consist of string, cord, tube, textile tape, wire and/or elastic band. The use of commercially obtainable plectrums for plectrums 3, 5 is there for conceivable and then privude them with drilled holes 15 so that they can be connected by threading through the connection material 7″. The ring of connection element 7″ only needs to be closed afterwards: this can be done by using any kind of connection, by using a knot for example.

Plectrum 1 is held in a similar way to the examples already described above with the difference that connection element 7″ does not lie on the tip of the forefinger but on the inside surface of the finger. The opportunity for the player to influence the distance of striking edges 11, 13 by moving the thumb comes into effect here especially when a rubber band is used in a similar way as connection element 7″ can also be pulled over the forefinger. The plane of the ring is basically vertical to the playing plane.

The connection material of the plectrum hand, if necessary, the related drilled holes can also be freely positioned on the single plectrums and the wides possible variety of connection material can be combined with the widest possible range of connection elements and position of the connection material. Punched holes in the form of slots or any preferred shape of removed material which encroaches into the connection material can be provided instead of drilled holes. This can provide better protection against the connection material becoming twisted relative to the single plectrums so that stability of the plectrum is generally increated. Differing connection elements produce differing sensory feedbacks for the player. The connection material can be selected to adapt the plectrums to the individual preferences of the player and to the various pieces and styles of music. The shape of the plectrum and therefore the shape of the single plectrums can also be freely varied. Differing shapes of single plectrums can also be combined with each other. The only important consideration here is that the plectrum has more than one striking edge and/or that the player can vary the relative spatial relationchip of these striking edges relative to edge other. The coupling of more than two single plectrums by using the connection elements described here is also possible so that more than two strings can be easily struck.

1. Plectrum for striking strings, with at least two stroking edges (11, 13) for striking several stings at the same time and/or striking one string one string or several strings at different times, and with at least two individual plectrums (3, 5) connected via a connection element (7, 7′, 7″) distinguished by the fact, that the connection element (7, 7′, 7″) can be adapted to the index finger of the hand for holding the plectrum (1) with one hand.

2. Plectrum in accordance with right 1, distinguished by the fact, that the connection element (7, 7′, 7″) has elastic properties in a longitudinal and/or latitudinal direction.

3. A plectrum in accordance with one of the claims stated in 1 or 2 distinguished by the fact, that the connection element has bending properties (7, 7′, 7″), containing either a foil, a string, a cord, a tube, a textile tape, a wire and/or an elastic band.

4. Plectrum in accordance with one of the claims, distinguished by the fact, that the connection element (7) is made out of material strips or wire.

5. A plectrum in accordance with one of the claims stated above, distinguished by the fact, that the connection element (7) and the minimum of two individual plectrums (3, 5) are constructed to form a single unit.

6. A plectrum in accordance with one of the claims stated above, distinguished by the fact that the minimum of two individual plectrums (3, 5) are standard production items which are commercially available.

7. A plectrum in accordance with one of the claims stated above, distinguished by the fact, that the plectrum (1) and/or the connection element (7, 7′, 7″) have some means of connection (9, 9′), especially in the form of rivets and/or drilled holes (15) and/or glued joints and/or locking elements and/or screws and/or welted points.

8. A plectrum according to the previously described claims, distinguished by the fact, that the plectrum (1) is positioned between thumb and index finger and between the index finger and the middle finger, and that the connection element (7, 7′, 7″) travels over the upper side, or the lower side of the index finger.
